(19) United States
(12) Patent Application Publication
(10) Pub. No.: US 2012/0105444 A1
(43) Pub. Date: May 3, 2012

(54) DISPLAY PROCESSING APPARATUS, DISPLAY PROCESSING METHOD, AND DISPLAY PROCESSING PROGRAM

(75) Inventor: Takahiro Tokuda, Tokyo (JP)

(73) Assignee: SONY CORPORATION, Tokyo (JP)

(21) Appl. No.: 13/276,539

(22) Filed: Oct. 19, 2011

(30) Foreign Application Priority Data
Nov. 2, 2010 (JP) P2010-246737

(51) Int. Cl. G06T 15/00

(52) U.S. Cl. 345/419

(57) ABSTRACT

A display processing apparatus includes an image acquisition unit that acquires a left eye image and a right eye image of a stereoscopic image, a parallax calculation unit that calculates a parallax for each of image elements contained in the left eye image and the right eye image, an area setting unit that sets, as a blur area, an area of an image element for which the parallax is less than a predetermined threshold among the image elements contained in a selection image selected as the left eye image or the right eye image, a blurring unit that applies blurring to the blur area in the selection image, and a display control unit that alternately displays the selection image to which the burring has been applied and the selection image to which the burring has not been applied yet.

### BACKGROUND

The present disclosure relates to a display processing apparatus, display processing method, and display processing program and, more particularly, to a display processing apparatus, display processing method, and display processing program that display 3D contents in a pseudo-stereoscopic manner.

Because of the widespread use of 3D contents containing 3D images or pictures, 3D displays etc. for stereoscopically displaying 3D contents are becoming more popular. Since 3D displays are not widely available as compared with 3D contents, however, 3D contents are often displayed on a 2D display of the related art. In this case, 3D contents are two-dimensionally displayed on a 2D display with an icon indicating 3D contents. Accordingly, it is difficult for the user to intuitively understand the true image of 3D contents.

### SUMMARY

There has been a related-art technique for generating pseudo-3D contents by applying image processing to 2D contents. However, this technique is not appropriate for the pseudo-stereoscopic display of 3D contents in order to easily grasp the true image of 3D contents because it uses much calculation resource for characteristic extraction etc.

It is desirable to provide a display processing apparatus, display processing method, and display processing program that can display 3D contents in a pseudo-stereoscopic manner.

According to an embodiment of the present disclosure, there is provided a display processing apparatus including an image acquisition unit that acquires a left eye image and a right eye image of a stereoscopic image, a parallax calculation unit that calculates a parallax for each of image elements contained in the left eye image and the right eye image, an area setting unit that sets, as a blur area, an area of an image element for which the parallax is less than a predetermined threshold among the image elements contained in a selection image selected as the left eye image or the right eye image, a blurring unit that applies blurring to the blur area in the selection image, and a display control unit that alternately displays the selection image to which the burring has been applied and the selection image to which the burring has not been applied yet.

The display processing apparatus may further include an edge detecting unit that detects an edge component forming a boundary of the image element in an image horizontal direction for the left eye image and the right eye image, in which the parallax calculation unit may calculate the parallax based on a difference in the position in the image horizontal direction of the edge component in the left eye image and the right eye image and the area setting unit may set, as the blur area, an area along the edge component for which the parallax is less than a predetermined threshold among the edge components contained in the selection image.

The edge detecting unit may also detect, as the edge component, a pixel having a difference in brightness or color that is equal to or more than a predetermined threshold with a left or right adjacent pixel for the left eye image and the right eye image.

The edge detecting unit may also detect, as the edge component, a pixel having a difference between a difference in brightness or color with an left adjacent pixel and a difference in brightness or color with an right adjacent pixel that is equal to or more than a predetermined threshold, for the left eye image and the right eye image.

The blurring unit may give a larger blurring effect to the blur area as the parallax is smaller.

The blurring unit may give a larger width to the blur area as the parallax is smaller.

The display processing apparatus may further include an image display unit that alternately displays the selection image to which the blurring has been applied and the selection image to which the blurring is not applied yet, under control of the display control unit.

According to another embodiment of the present disclosure, there is provided a display processing method including acquiring a left eye image and a right eye image of a stereoscopic image, calculating a parallax for each of image elements contained in the left eye image and the right eye image, setting, as a blur area, an area of an image element for which the parallax is less than a predetermined threshold among the image elements contained in a selection image selected as the left eye image or the right eye image, applying blurring to the blur area in the selection image, and alternately displaying the selection image to which the blurring has been applied and the selection image to which the blurring has not been applied yet.

According to another embodiment of the present disclosure, there is provided a display processing program letting a computer execute the above display processing method. Here, the program may be provided through a computer-readable recording medium 34 or a communication device.

According to an embodiment of the present disclosure, it is possible to provide a display processing apparatus, display processing method, and a display processing program that display 3D contents in a pseudo-stereoscopic manner.

### BRIEF DESCRIPTION OF THE DRAWINGS

FIG. 1 is a block diagram showing the structure of a display processing apparatus according to an embodiment of the present disclosure.

FIG. 2 is a block diagram showing an example of the hardware structure of the display processing apparatus.

FIG. 3 is a flowchart describing a procedure of a display processing method according to an embodiment of the present disclosure.

FIG. 4 is a flowchart describing another procedure of the display processing method according to the embodiment of the present disclosure.

FIG. 5 shows an example of a subject captured as a stereoscopic image.

FIG. 6 shows examples of a left eye image and a right eye image of a stereoscopic image in which the subject shown in FIG. 5 is captured.

FIG. 7 shows edge images including edge components detected from the left eye image and the right eye image shown in FIG. 6.

FIG. 8A shows an example of detecting edge components in a partial area of the left eye image shown in FIG. 6 (1/2).

FIG. 8B shows the example of detecting edge components in the partial area of the left eye image shown in FIG. 6 (2/2).

FIG. 9A shows another example of detecting the edge components shown FIGS. 8A and 8B (1/2).

FIG. 9B shows the other example of detecting the edge components shown FIGS. 8A and 8B (2/2).

FIG. 10 shows a parallax acquired on the basis of the difference between the positions of the edge components shown in FIG. 7.

FIG. 11A shows an example of calculating a parallax in a partial area of the left eye image shown in FIG. 6 (1/2).

FIG. 11B shows the example of calculating the parallax in the partial area of the left eye image shown in FIG. 6 (2/2).

FIG. 12 shows an example of setting a blur area in a partial area of a selection image.

FIG. 13 shows another example of setting the blur area shown in FIG. 12.

FIG. 14 shows an example of a selection image to which blurring has been applied.

FIG. 15 shows the alternate display of the selection image to which the blurring shown in FIG. 13 has been applied and the selection image to which the blurring has not been applied yet.

### DETAILED DESCRIPTION OF EMBODIMENTS

An embodiment of the present disclosure will now be described in detail with reference to the drawings. In the embodiment below, like elements may be denoted by like reference characters, and repeated descriptions may be omitted.

### [1. Structure of a Display Processing Apparatus 10]

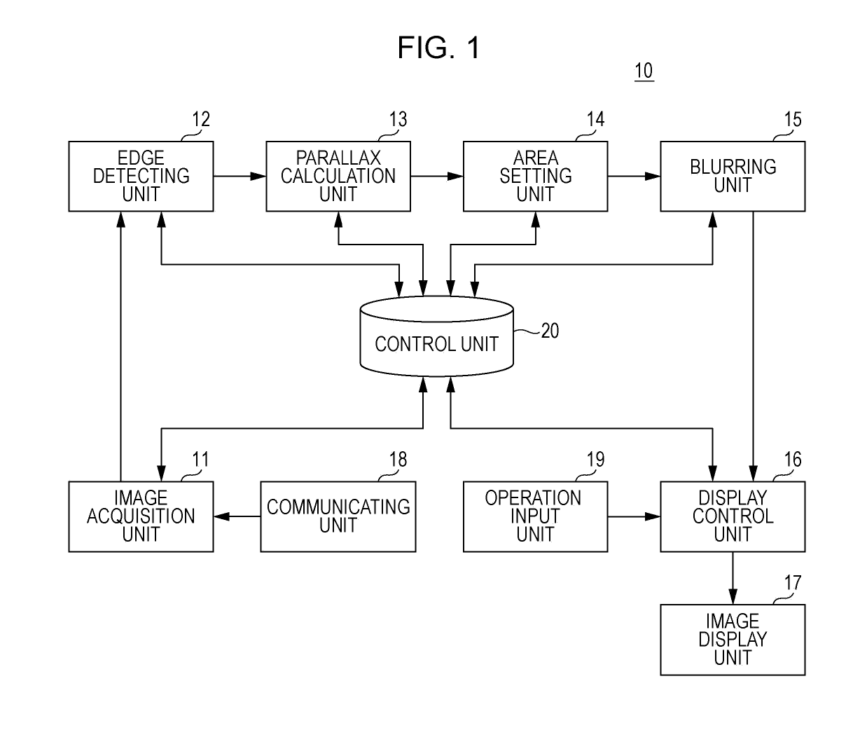

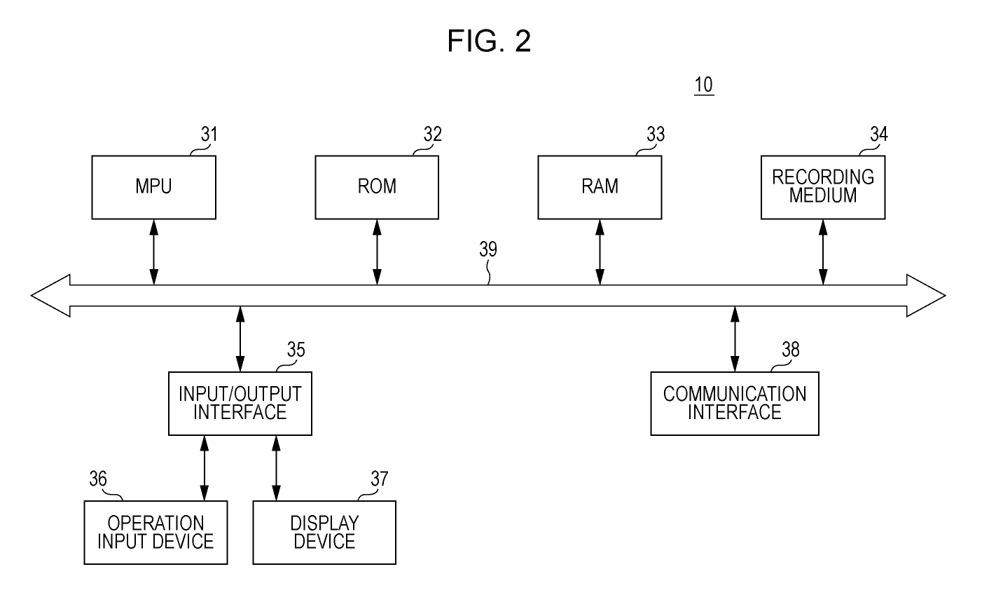

First, the structure of a display processing apparatus 10 according to an embodiment of the present disclosure will be described with reference to FIGS. 1 and 2.

The display processing apparatus 10 according to the embodiment of the present disclosure is a 2D display of the related art. The display processing apparatus 10 may be a television set, personal computer, personal digital assistant, mobile phone, video player, game player, or a part of these devices. The display processing apparatus 10 may be of an arbitrary display type such as liquid crystal type, plasma type, or organic EL type.

FIG. 1 shows the structure of the display processing apparatus 10 according to the embodiment of the present disclosure. As shown in FIG. 1, the display processing apparatus 10 includes an image acquisition unit 11, an edge detecting unit 12, a parallax calculation unit 13, an area setting unit 14, a blurring unit 15, a display control unit 16, an image display unit 17, a communicating unit 18, an operation input unit 19, and a memory unit 20. In FIG. 1, only main functions of the display processing apparatus 10 are indicated.

The image acquisition unit 11 acquires a left eye image Pl and a right eye image Pr of a stereoscopic image Pa. In the stereoscopic image Pa, a parallax d (representing a parallax collectively) between the left and right eyes is used to make the image stereoscopic. The stereoscopic image Pa includes the left eye image Pl recognized by the left eye and the right eye image Pr recognized by the right eye. These images may be acquired as separate images. They may be acquired as an integrated image and then it may be separated into the left eye image Pl and the right eye image Pr. These images may be acquired from the memory unit 20 or from an external device (not shown) through the communicating unit 18. The acquired image is provided for the edge detecting unit 12. The following description assumes that these images are related to each other and stored in the memory unit 20 as separate images.

The edge detecting unit 12 detects an edge component forming the boundary of an image element in the image horizontal direction for the left eye image Pl and the right eye image Pr. The edge component is detected as the pixel having a difference in brightness b (representing brightness collectively) and/or color that is equal to or more than a predetermined threshold among pixels that are adjacent or close to each other in the image horizontal direction in these images. To detect the edge component, these images are processed as data including brightness components in the case of a monochrome image or as data including R, G, and B components or Y, Cb, and Cr components in the case of a color image. The result of detection of the edge component is provided for the parallax calculation unit 13 as positional information. When no edge components are used to calculate the parallax d (representing a parallax collectively) or set the blur area pb, an element for detecting other image elements used to calculate the parallax d or set the blur area pb is provided, instead of the edge detecting unit 12.

The parallax calculation unit 13 calculates the parallax d for each of image elements contained in the left eye image Pl and the right eye image Pr. The parallax calculation unit 13 particularly calculates the parallax d based on the difference between the positions in the image horizontal direction of the edge components of the left eye image Pl and the right eye image Pr. The image elements are image components that can be used to calculate the parallax d and image elements may be edge components or other components. In the present embodiment, the following description assumes that the parallax d is calculated on the basis of the difference between the positions in the image horizontal direction of the edge components. The result of calculation of the parallax d is provided for the area setting unit 14 as the parallax d for each of the edge components. The result of calculation of the parallax d is preferably stored in the memory unit 20.

The area setting unit 14 sets, as the blur area pb, the area of the image element for which the parallax d is less than a predetermined threshold dt among image elements contained in a selection image selected as the left eye image Pl or the right eye image Pr. The area setting unit 14 particularly sets, as the blur area pb, the area along the edge component for which the parallax d is less than the predetermined threshold dt among the image elements contained in a selection image.

The selection image is used to display the stereoscopic image Pa in a pseudo-stereoscopic manner. As described later, the selection image is used for stereoscopic display as a combination of the selection image (referred to below as the blurred selected image) to which blurring has been applied and the selection image (referred to below as the unblurred selected image) to which blurring has not been applied yet. The image element, which is an image component that can be used to set the blur area pb, may be an edge component or other component. In the embodiment, the following description assumes that blur area pb is set along an edge component.

The blur area pb is set as, for example, a pixel area with a certain width. As described later, a subject O (representing a subject collectively) positions on a farther side in the selection image as the parallax d of the edge components is smaller. Accordingly, setting the blur area pb along the edge component for which the parallax d is less than the predetermined threshold dt applies blurring to the subject O that positions on the farther side in the selection image. The result of setting of the blur area pb is provided for the blurring unit 15 as positional information in the selection image.

The blurring unit 15 applies blurring to the blur area pb in the selection image. In blurring, the brightness is reduced or the color is lightened for the pixels in the blur area pb to make edge component unclear. The result of blurring is stored in the memory unit 20 as the blurred selection image. The memory unit 20 stores the unblurred selection image (that is, the selection image), which is related to the blurred selection image.

The operation input unit 19 receives an operation input from the user. The operation input unit 19 is configured as, for example, a remote controller, button, switch, keyboard, mouse, or touch pad.

The display control unit 16 alternately displays the blurred selection image and the unblurred selection image on the image display unit 17. The display control unit 16 reads these images from the memory unit 20 and provides them alternately for the image display unit 17. That is, after displaying one image, the display control unit 16 displays the other image instead when a predetermined condition is satisfied and repeats the alternate display in the same way. The alternate display may be performed at predetermined time intervals automatically or by input operation from the operation input unit 19 manually.

The communicating unit 18 transmits or receives image data about the stereoscopic image Pa to or from an external device. The image data may be image data supplied to the image acquisition unit 11 or may be data supplied to the image display unit 17. The external device may be an imaging device such as a still camera or video camera or may be a television apparatus, personal computer, personal digital assistant, mobile phone, video player, game player, etc.

The memory unit 20 stores image data about the stereoscopic image Pa. The memory unit 20 stores at least the blurred selection image and the unblurred selection image. The memory unit 20 may store the result of detection of an edge component, the result of calculation of a parallax d, or the result of setting of a blur area pb, etc.

FIG. 2 shows an example of the hardware structure of the display processing apparatus 10. As shown in FIG. 2, the display processing apparatus 10 includes an MPU 31, a ROM 32, a RAM 33, a recording medium 34, an input/output interface 35, an operation input device 36, a display device 37, a communication interface 38, and a bus 39. The bus 39 interconnects the MPU 31, the ROM 32, the RAM 33, the recording medium 34, the input/output interface 35, and the communication interface 38.

The MPU 31 controls the operation of the display processing apparatus 10 by reading a program stored in the ROM 32, the RAM 33, the recording medium 34, etc., loading the program onto the RAM 33, and executing it. The MPU 31 particularly operates as the image acquisition unit 11, the edge detecting unit 12, the parallax calculation unit 13, the area setting unit 14, the blurring unit 15, and the display control unit 16. An element related particularly to display processing may be configured as a dedicated processor etc. The RAM 33 and/or the recording medium 34 operate as the memory unit 20.

The input/output interface 35 receives or outputs data etc. from or to an external device (not shown) connected to the display processing apparatus 10. The operation input device 36 has a keyboard, mouse, touch panel, etc. and supplies an operation input that was input through a device to the MPU 31 through the input/output interface 35. The display device 37, for example, alternately displays the blurred selection image and the unblurred selection image, which will be described in detail later. The display device 37 operates particularly as the image display unit 17. The communication interface 38 transmits or receives image data etc. to or from an external device through a communication line. The communication interface 38 operates particularly as the communicating unit 18.

### [2. Operation of the Display Processing Apparatus 10]

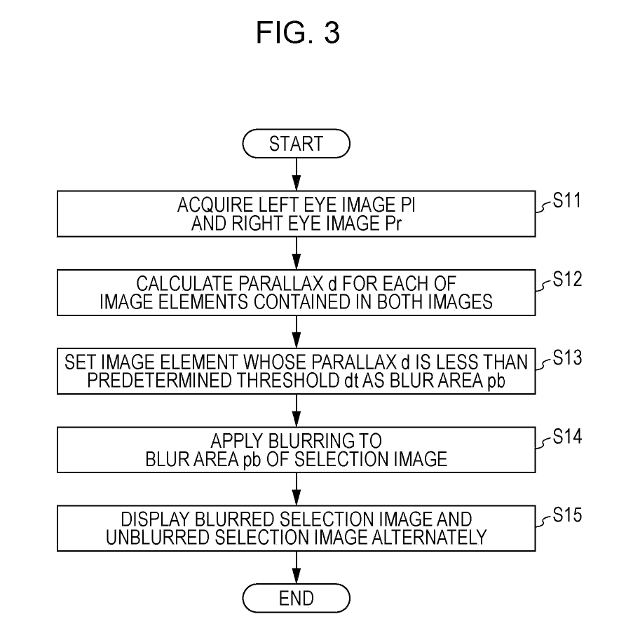

Next, the operation of the display processing apparatus 10 according to the embodiment of the present disclosure will be described with reference to FIGS. 3 to 15.

FIG. 3 shows a procedure of a display processing method according to the embodiment of the present disclosure. As shown in FIG. 3, in the display processing apparatus 10, the image acquisition unit 11 first acquires the left eye image Pl and right eye image Pr of the stereoscopic image Pa (step S11). Next, the parallax calculation unit 13 calculates the parallax d for each of image elements contained in both images (step S12). Next, the area setting unit 14 sets, as the blur area pb, the area of the image element for which the parallax d is less than a predetermined threshold dt among image elements contained in a selection image selected as the left eye image Pl or the right eye image Pr (step S13). Next, the blurring unit 15 applies blurring to the blur area pb of the selection image (step S14). The display control unit 16 alternately displays the blurred selection image and the unblurred selection image on the image display unit 17 (step S15). The selection image is selected at an arbitrary point in time before the blur area pb is set.

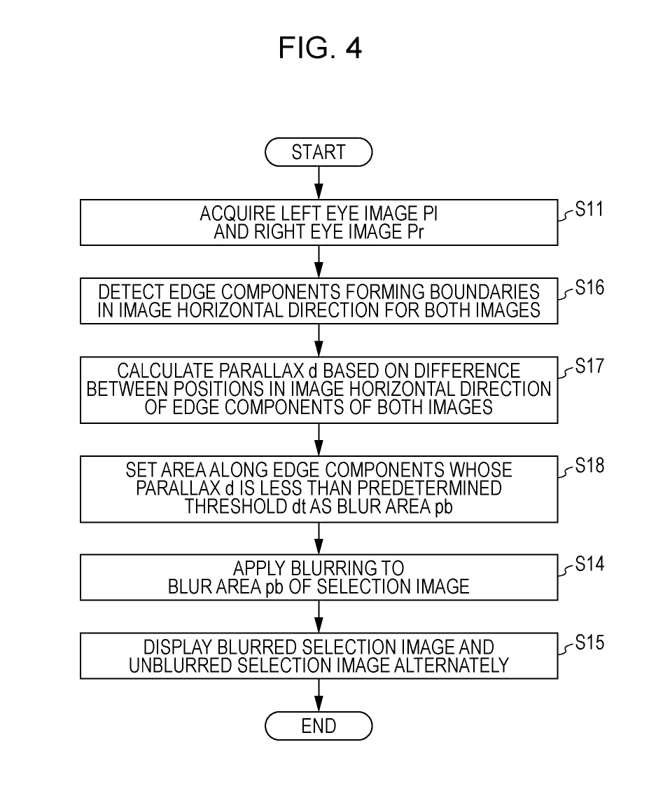

FIG. 4 shows another procedure of the display processing method according to the embodiment of the present disclosure. In this procedure, calculation of the parallax d and setting of the blur areas pb are performed on the basis of the edge components. As shown in FIG. 4, when both images are acquired (step S11), the edge detecting unit 12 detects the edge component forming the boundary of image element in the image horizontal direction for each image (step S16). Next, the parallax calculation unit 13 calculates the parallax d based on the difference between the positions in the image horizontal direction of edge components of both images (step S17). Next, the area setting unit 14 sets, as the blur area pb, the area along the edge element for which the parallax d is less than a predetermined threshold dt among image elements contained in a selection image (step S18). After blurring is applied to the selection image (step S14), the blurred selection image and the unblurred selection image are displayed alternately (step S15).

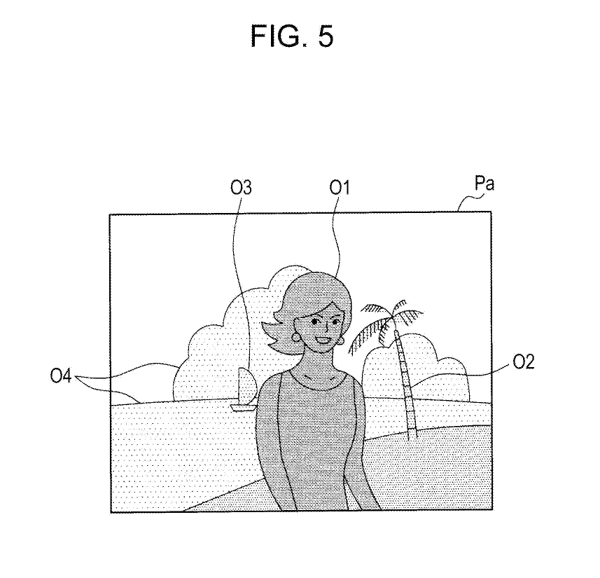

The following describes the display processing method based on edge components shown in FIG. 4, with reference to FIGS. 5 to 15.

FIG. 5 shows examples of subjects O captured as the stereoscopic image Pa. As shown in FIG. 5, in the stereoscopic image Pa, a person O1, which is a foreground, a tree O2, a yacht O3, and a cloud and horizontal line O4, which are backgrounds, are captured as subjects O. These subjects O are arranged at certain intervals in the depth direction of the image. More specifically, the person O1, the tree O2, the yacht O3, and the cloud and horizontal line O4 are arranged in this order at certain intervals. In the stereoscopic image Pa, in which the subjects O shown in FIG. 5 are captured, the subject O1 is arranged on the nearer side of the image as a foreground, and the objects O2, O3, and O4 are arranged on the farther side as backgrounds. FIG. 5 only shows examples of subjects O captured as the stereoscopic image Pa and the embodiment of the present disclosure is applied to a stereoscopic image Pa that captures a plurality of subjects O arranged at certain intervals in the depth direction. In the stereoscopic image Pa, denser hatching is applied to a subject located on a nearer side of the image.

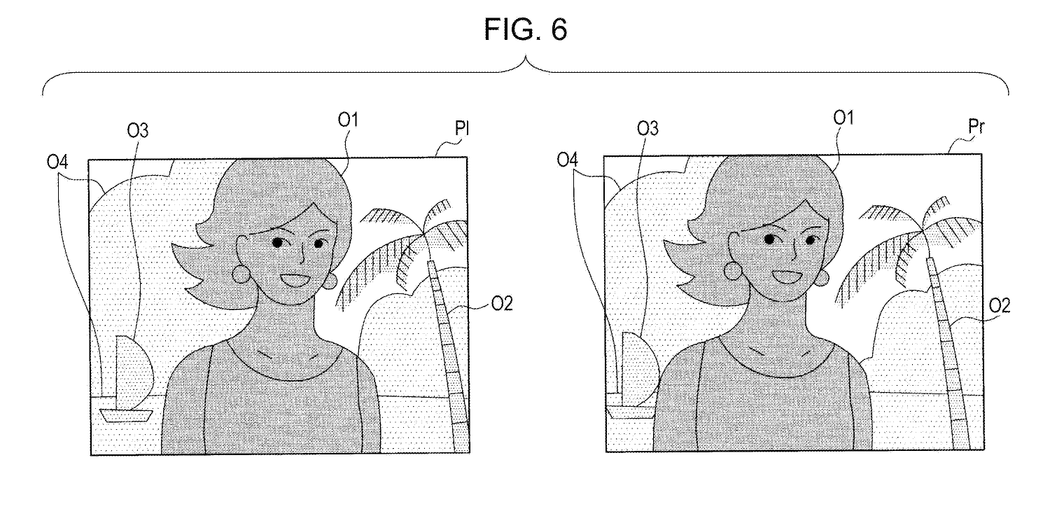

FIG. 6 shows examples of a left eye image Pl and a right eye image Pr of the stereoscopic image Pa in which the subjects O shown in FIG. 5 are captured. A part of the subjects O shown in FIG. 5 are captured in the left eye image Pl and the right eye image Pr. As shown in FIG. 6, when the left eye image Pl is compared with the right eye image Pr, the foreground subject O1, which easily causes a parallax d, has a change in the position in the image horizontal direction. That is, in the left eye image Pl, the foreground subject O1 displaces to the right relative to the background subjects O2 to O4; in the right eye image Pr, the foreground subject O1 displaces to the left relative to the background subjects O2 to O4. On the other hand, the background subjects O2 to O4, which do no easily cause a parallax d, are located almost in the same positions between the left eye image Pl and the right eye image Pr. More specifically, the displacement is smaller than in the foreground subject O1, but the displacement in the image horizontal direction increases as a subject O is arranged on a nearer side, that is, in the order of the tree O2, the yacht O3, and the cloud and horizontal line O4. In the left eye image Pl and the right eye image Pr, denser hatching is applied to a subject arranged on a nearer side of the image.

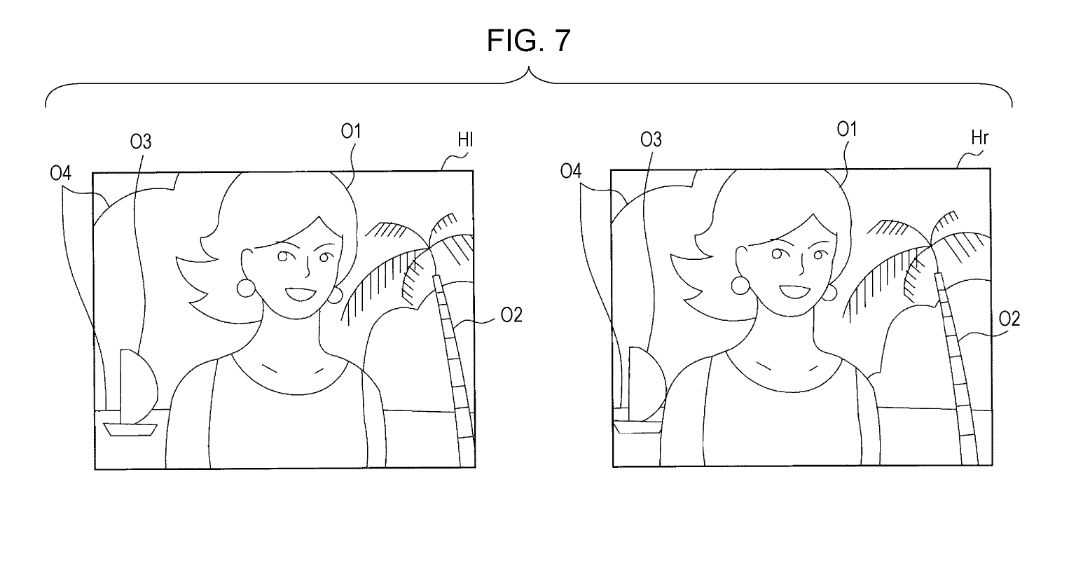

FIG. 7 shows edge images Hl and Hr formed by edge components detected from the left eye image Pl and the right eye image Pr shown in FIG. 6. As shown in FIG. 7, the edge components are detected along the contours of the subjects O. The result of detection of the edge components differs between the left eye image Pl and the right eye image Pr depending on the state of occurrence of the parallax d. Here, the result of detection of the edge components is represented as the positional information of the edge components in each image. The result of detection of the edge components may be represented as coordinate information of pixels or as matrix information indicating presence or absence of the edge components.

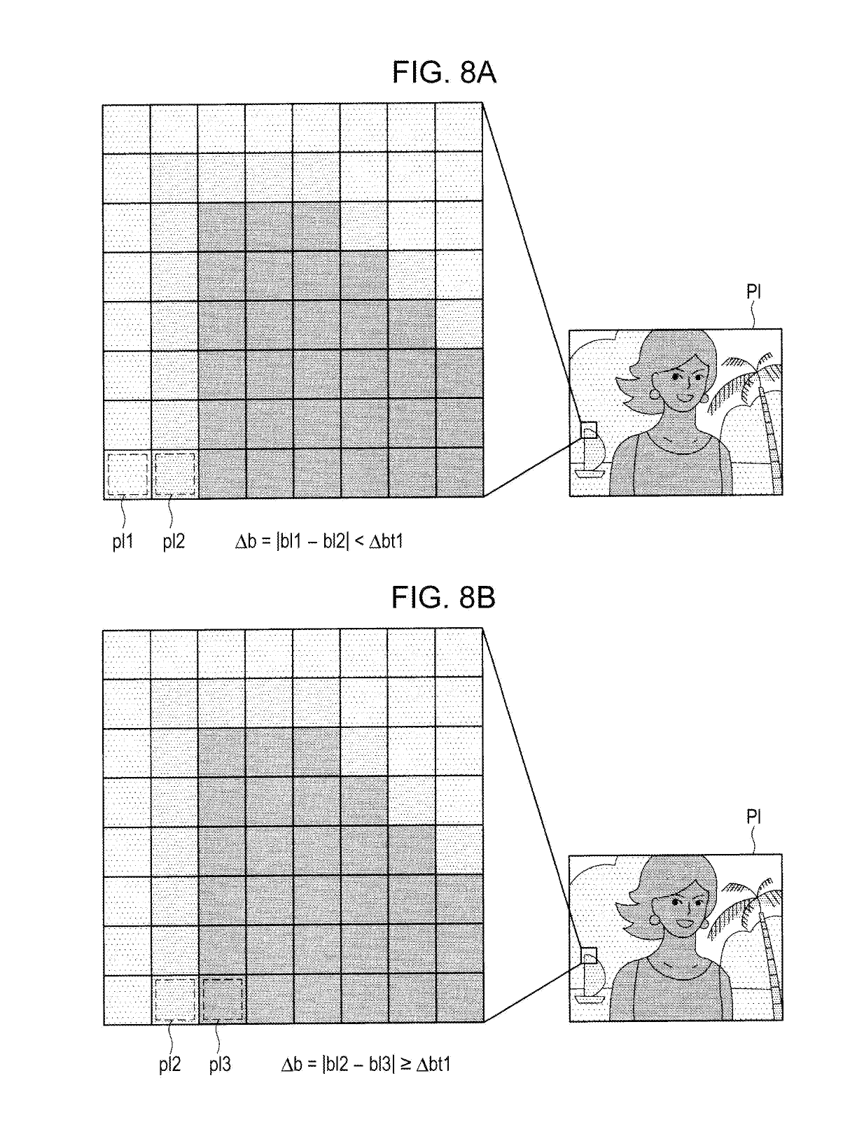

FIGS. 8A and 8B show examples of detecting edge components in a partial area representing a part of the yacht in the left eye image Pl shown in FIG. 6. In examples shown in FIGS. 8A and 8B, the pixels that are adjacent to each other in the image horizontal direction and have a brightness difference Δb (representing a brightness difference collectively) equal to or more than a predetermined threshold Δbt1 are detected as the edge components. The edge components may be detected on the basis of the color difference or on the basis of the brightness difference Δb and the color difference.

In FIG. 8A, the brightness bl1 of a pixel pl1 and the brightness bl2 of its adjacent pixel pl2 are read and then compared with each other. In this case, the brightness difference Δb is represented by |bl1−bl2|<Δbt1, so neither the pixel pl1 nor the pixel pl2 is not detected as an edge component. In FIG. 8B, the left eye image Pl is scanned to the right, and the brightness bl2 of a pixel pl2 and the brightness bl3 of its adjacent pixel pl3 are read and then compared with each other. In this case, the brightness difference Δb is represented by |bl2−bl3|≧Δbt1, so either the pixel pl2 or the pixel pl3 is detected as an edge component. The left pixel (such as pl2) or the right pixel (pixel pl3) can be used as the edge component as long as this rule is applied to both the left eye image Pl and the right eye image Pr. However, the following description assumes that the left pixel is used as the edge component.

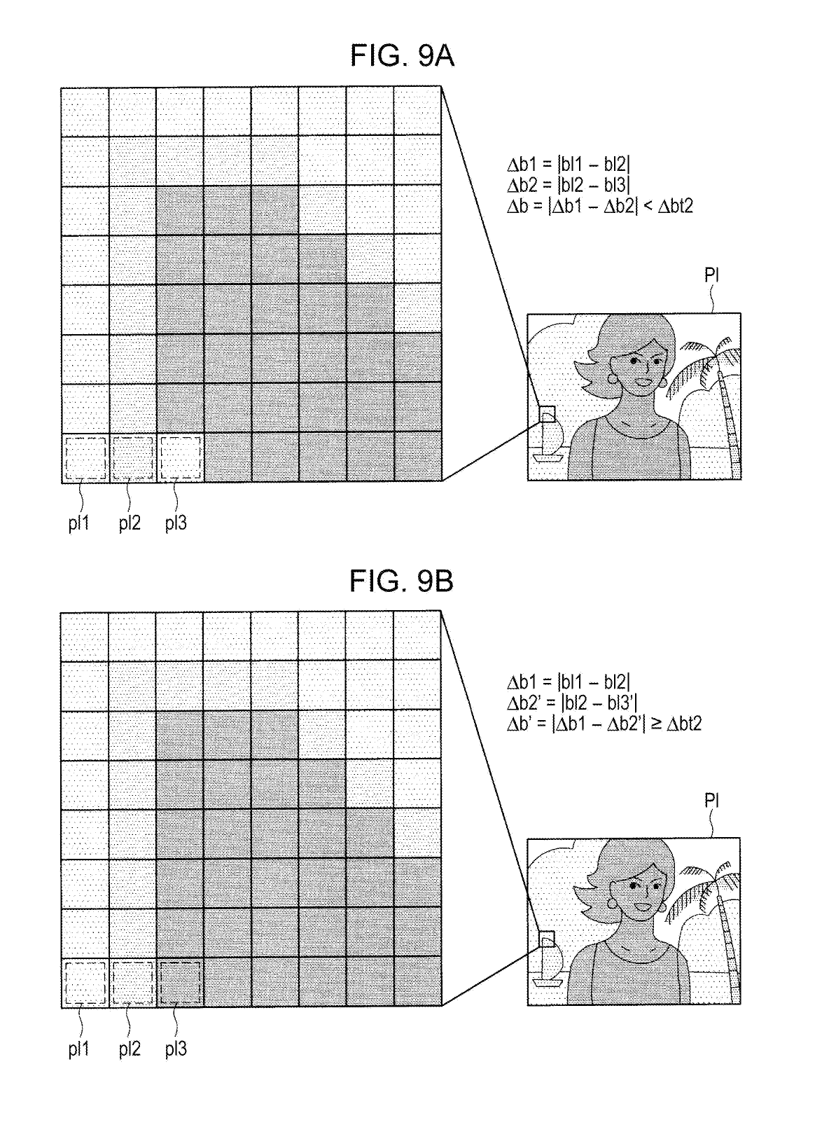

FIGS. 9A and 9B indicate other examples of detecting edge components in the cases shown in FIGS. 8A and 8B. In the examples shown in FIGS. 9A and 9B, the pixels that are adjacent to each other in the image horizontal direction and have a brightness difference Δb equal to or more than a predetermined threshold Δbt2 are detected as the edge components. The predetermined threshold Δbt2 may be the same as or different from the predetermined threshold Δbt1. The edge components may be detected on the basis of the color difference or both the brightness difference Δb and the color difference.

In FIG. 9A, the brightness bl1, the brightness bl2, and the brightness bl3 of adjacent pixels pl1, pl2, and pl3 are read. Next, a first brightness difference Δb1=|bl1−bl2| and a second brightness difference Δb2=|bl2−bl3| are obtained and then compared with each other. In this case, the difference Δb=|Δb1−Δb2| is less than Δbt2, the pixel pl2 is not detected as an edge component. On the other hand, in FIG. 9B, the brightness bl3′ of the pixel pl3 is different from the brightness bl3 shown in FIG. 9A. In this case, the difference Δb′=|Δb1−Δb2′| is equal to or more than Δbt2, the pixel pl2 is detected as an edge component.

FIGS. 8A, 8B, 9A, and 9B show examples of detecting edge components in a partial area representing a part of the yacht O3 in the left eye image Pl. However, in the left eye image Pl, the edge component of another subject O is detected similarly. Also in the right eye image Pr, the edge component is detected similarly. In the example of detecting the edge component, the image elements in a partial area in the left eye image Pl are schematically represented.

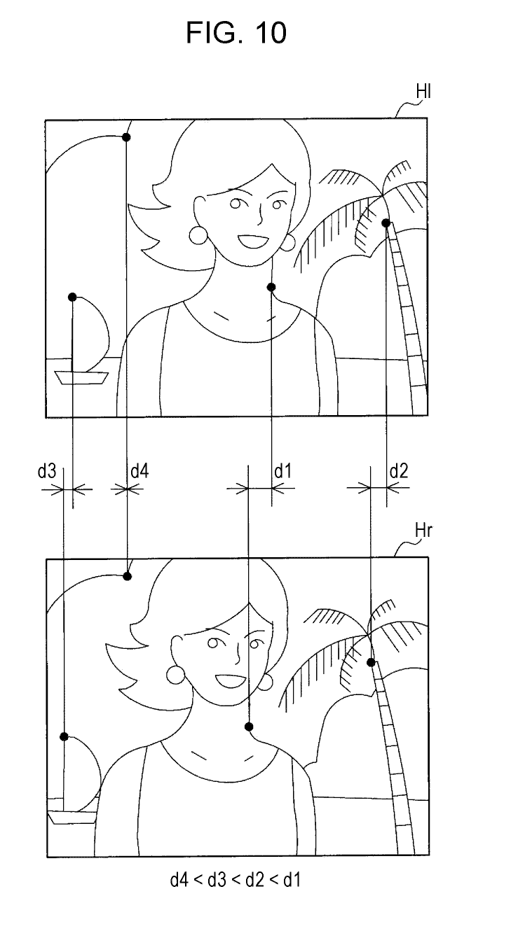

FIG. 10 shows parallaxes d obtained on the basis of differences in the positions of the edge components shown in FIG. 7. The subjects O in the left eye image Pl displace to the right relative to the subjects O in the right eye image Pr; the subjects O in the right eye image Pr displace to the left relative to the subjects O in the left eye image Pl. In FIG. 10, the edge image Hl of the left eye image Pl is arranged above the edge image Hr of the right eye image Pr to indicate parallaxes d1, d2, d3, and d4 of parts of the edge components of the person O1, the tree O2, the yacht O3, and the cloud and horizontal line O4. Here, the result of calculation of parallaxes d is represented as information related to each of the edge components. The parallax d of each edge component may be different for the same subject O, but the following description assumes that the parallax d is identical for each subject O for simplicity.

As shown in FIG. 10, a relatively large parallax d1 is observed in the foreground subject O1, which easily causes the parallax d. On the other hand, in the subjects O2 to O4, which do not easily cause the parallax d, small parallaxes d2 and d3 are observed or a parallax d4 is zero. More specifically, the parallax d increases in the order of the cloud and horizontal line O4, the yacht O3, tree O2, and the person O1; the parallax d becomes larger as a subject O is arranged closer to the near side (d4<d3<d2<d1). The following description assumes that parallax d1=five pixels for the edge component of the person O1, parallax d2=three pixels for the edge component of the tree O2, parallax d3=two pixels for the edge component of yacht O3, parallax d4=zero pixels for the edge component of the cloud and horizontal line O4.

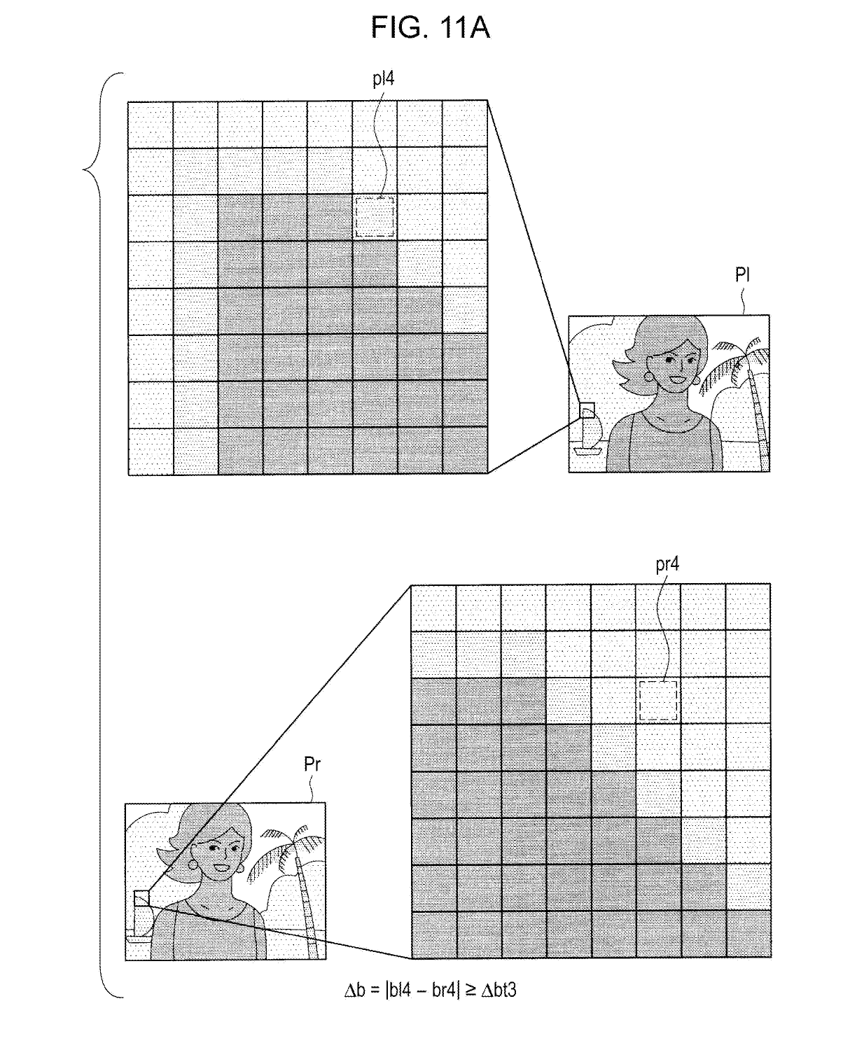

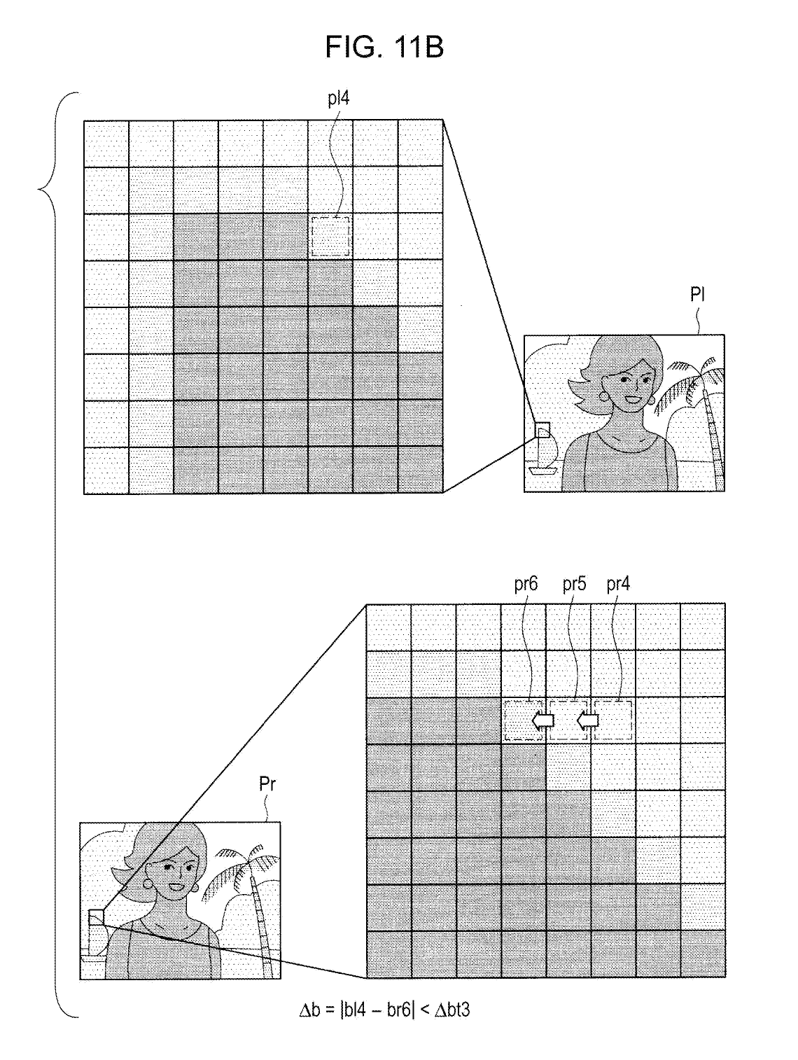

FIGS. 11A and 11B show examples of calculating the parallax d in a partial area representing a part of the yacht in the left eye image Pl shown in FIG. 6. In examples shown in FIGS. 11A and 11B, parallaxes d1 to d4 are calculated by comparing the edge components of the left eye image Pl with the edge components of the right eye image Pr. The following describes a method of calculating the parallax d by comparing the brightness difference Δb equivalent to the edge component with a predetermined threshold Δbt3 with respect to the left eye image Pl. The predetermined threshold Δbt3 may be identical to or different from predetermined threshold Δbt1 or Δbt2. The parallax d may be calculated on the basis of the color difference or may be calculated on the basis of the brightness difference Δb and the color difference. In examples of calculating the parallax d, image elements in a partial area in the left eye image Pl or the right eye image Pr are represented schematically.

As shown in FIG. 11A, in the left eye image Pl, the brightness bl4 of a pixel pl4 equivalent to arbitrary edge component is read. On the other hand, in the right eye image Pr, the brightness br4 of a pixel pr4 in the same position of the right eye image Pr is read on the basis of the positional information of the pixel pl4. Then, the brightness bl4 of the pixel pl4 is compared with the brightness br4 of the pixel pr4 to determine whether they are the same edge component. In this case, since Δb=|bl4−br4|≧Δbt3 is satisfied, it is not identified that the pixel pl4 and the pixel pr4 are the same edge component.

On the other hand, in FIG. 11B, the right eye image Pr is scanned to the left, and the brightness br5 of a pixel pr5 left adjacent to the pixel pr4 is read and compared with the brightness bl4 of the pixel pl4. Also in this case, since Δb=|bl4−br5|≧Δbt3 is satisfied, it is not identified that the pixel pl4 and the pixel pr5 are the same edge component. Next, the brightness br6 of a pixel pr6, which is second to the left of the pixel pr4, is read and compared with the brightness bl4 of the pixel pl4. In this case, since Δb=|bl4−br6|<Δbt3 is satisfied, it is identified that the pixel pl4 and the pixel pr6 are the same edge component. Accordingly, the parallax d of the edge component is calculated to two pixels and recorded by the parallax being related to the edge component.

When the same edge component is identified relative to the left eye image Pl, since the subjects O in the right eye image Pr are displaced to the left relative to the subjects O in the left eye image Pl, the right eye image Pr is scanned to the left. On the other hand, when the same edge component is identified relative to the right eye image Pr, since the subjects O in the left eye image Pl are displaced to the right relative to the subjects O in the right eye image Pr, the left eye image Pl is scanned to the right. This enables the same edge component to be identified efficiently.

In FIGS. 11A and 11B, the same edge component is identified on the basis of the brightness difference Δb of one pixel. However, the same edge component may be identified on the basis of the brightness difference Δb of adjacent pixels instead of one pixel to improve the accuracy of identifying the edge component. In the example shown in FIG. 11B, the same edge component is identified on the basis of the second adjacent pixel by scanning an image on a pixel-by-pixel basis. If the same edge component is not identified even when many pixels are scanned, identification of the same edge component may be suspended for the edge component.

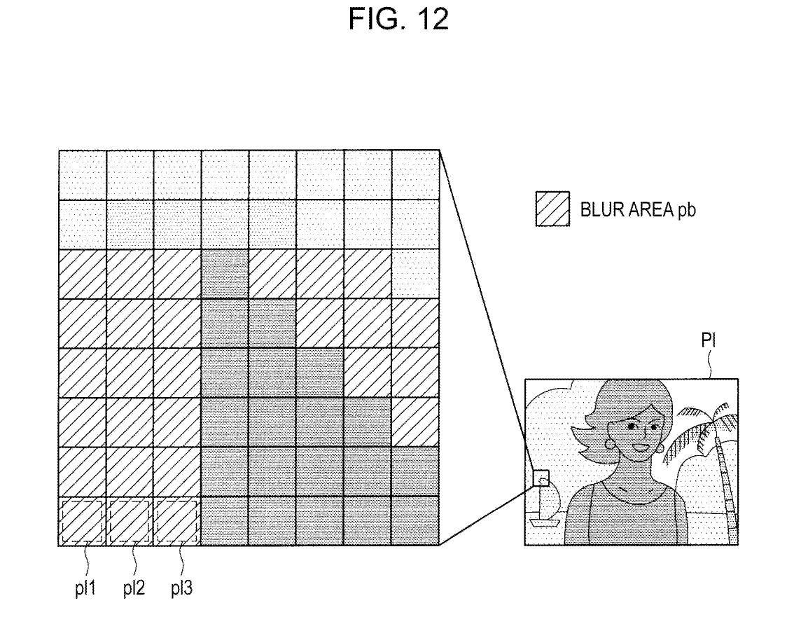

FIG. 12 shows an example of setting the blur area pb in a partial area of a selection image. FIG. 12 assumes that the left eye image Pl is selected as the selection image and the area along the edge component for which the parallax d is less than a predetermined threshold dt (5 pixels) is set as the blur area pb. The blur area pb may be set as the area along the edge component for which the parallax d is less than the predetermined threshold dt (10 pixels or 3 pixels). The result of setting of the blur area pb is represented as information related to each edge component. The result of setting of the blur area pb may be represented as coordinate information of the image or as matrix information indicating whether it is equivalent to the blur area pb.

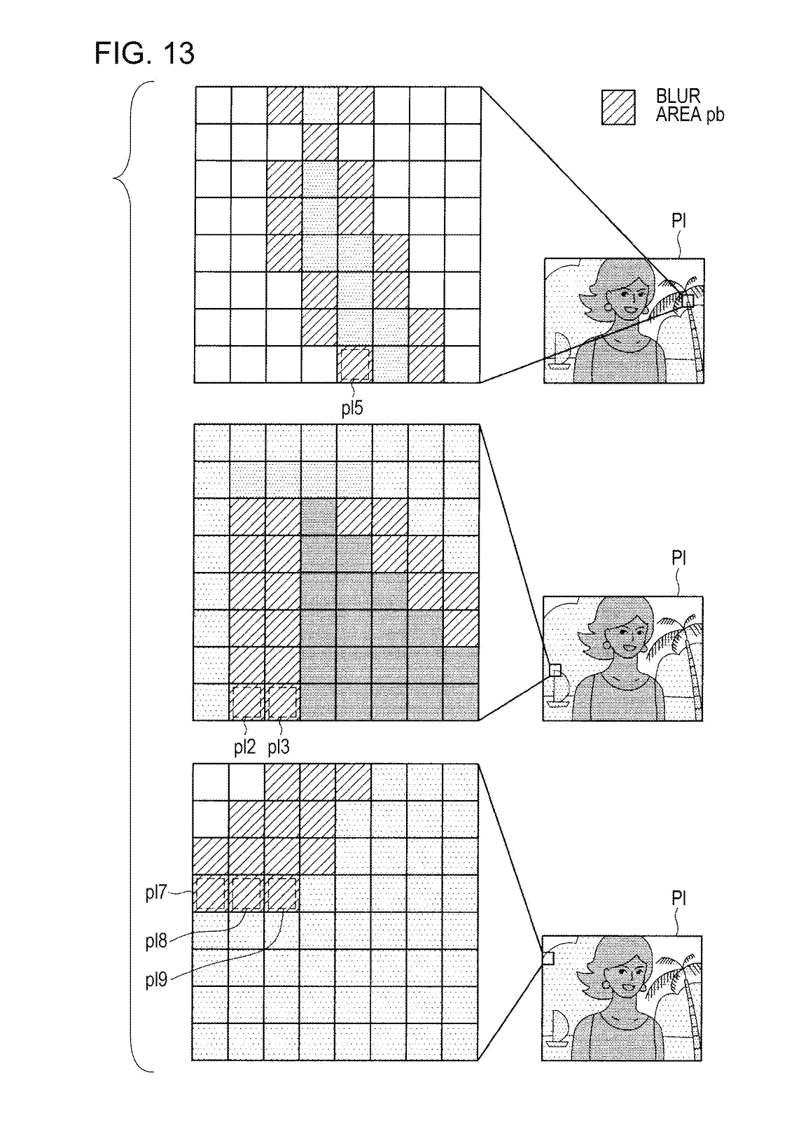

FIG. 12 shows an example of setting the blur area pb in a partial area representing a part of the yacht O3 in the selection image. In FIGS. 12 and 13, the blur area pb is indicated as a hatched area. As described above, the parallax d3 of two pixels are calculated for the edge component of the yacht O3. In this case, as shown in FIG. 12, an area with a width of three pixels including a pixel pl2 equivalent to an edge component and its left and right adjacent pixels pl1 and pl3 are set as the blur area pb. Similarly, an area with a width of three pixels along the edge component of the yacht O3 is set as the blur area pb.

Similarly, for the edge component of the tree O2 with a parallax d2 of three pixels and the cloud and horizontal line O4 with a parallax d4 of zero pixels, an area with a width of three pixels along the edge component is set as a blur area pb. On the other hand, for the edge component of the person O1 with a parallax d1 of five pixels, the blur area pb is not set because the parallax d is equal to or more than a predetermined threshold (less than five pixels). In the example of setting the blur area pb, image elements in a partial area in the left eye image Pl are schematically represented.

FIG. 13 shows another example of setting the blur area pb shown in FIG. 12. In the example shown in FIG. 13, an edge component with a smaller parallax d is provided with a wider blur area pb to give a larger blurring effect. For example, in an example shown in FIG. 10, the parallax d2 with three pixels, the parallax d3 with two pixels, and the parallax d4 with zero pixels are calculated for the edge components of the tree O2, the yacht O3, and the cloud and horizontal line O4, respectively.

FIG. 13 shows examples of setting the blur area pb in a partial area representing a part of the tree O2, a partial area representing a part of the yacht O3, and a partial area representing a part of the cloud and horizontal line O4 in a selection image. As shown in FIG. 13, an edge component with a smaller parallax d has a wider blur area pb to give a larger blurring effect. More specifically, the blur area pb with a width of one pixel such as a pixel pl5 is set for the edge component of the tree O2. The blur area pb with a width of two pixels such as pixels pl2 and pl3 is set for the edge component of the yacht O3. The blur area pb with a width of three pixels such as pixels pl7, pl8, and pl9 is set for the edge component of the cloud and horizontal line O4.

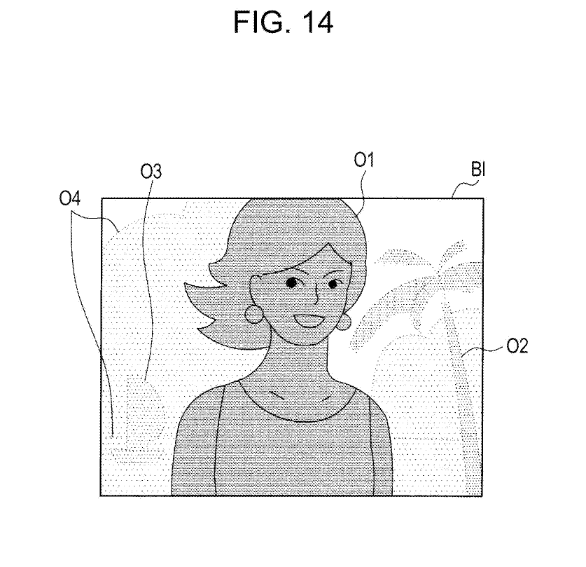

FIG. 14 shows a selection image obtained by applying blurring to the blur area pb shown in FIG. 12. In the selection image shown in FIG. 12, blurring is applied along the contours of the tree O2, the yacht O3, and the cloud and horizontal line O4. In blurring, for the pixels in the blur area pb in the selection image, for example, the brightness is reduced or the color is lightened. In FIG. 14, the result of blurring is shown by making the contours of the tree O2, the yacht O3, and the cloud and horizontal line O4 unclear. The blurred selection image is stored as the blurred selection image Bl, separately from the unblurred selection image Pl.

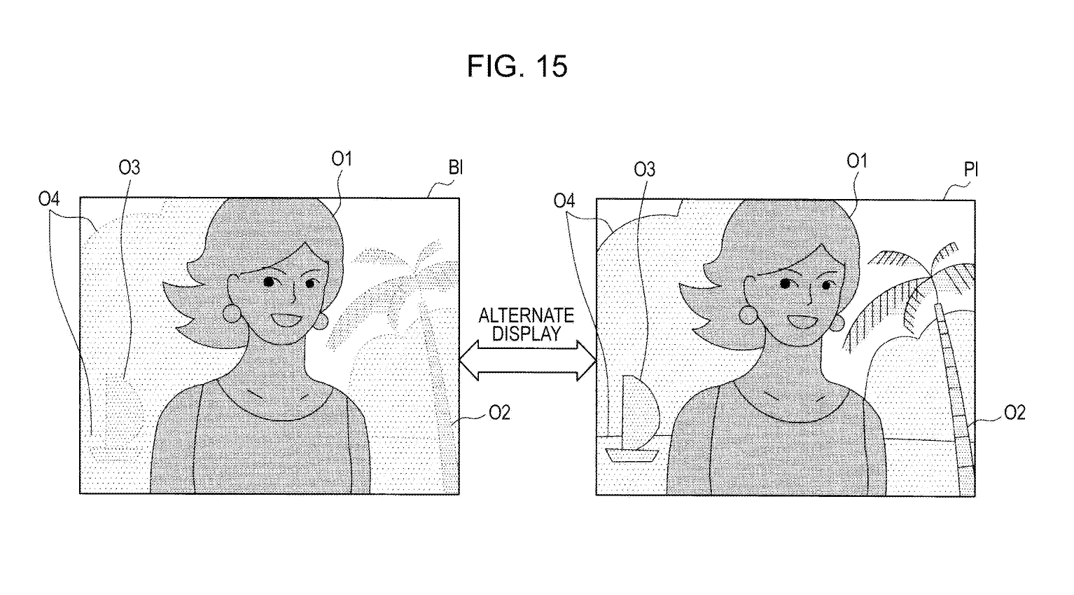

FIG. 15 shows alternate display of the blurred selection image Bl shown in FIG. 13 and the unblurred selection image Pl. After finishing blurring, the display processing apparatus 10 reads the blurred selection image Bl and the unblurred selection image Pl as shown in FIG. 15 and displays these images alternately. The alternate display may be performed automatically based on a lapse of a predetermined period of time or may be performed manually based on operation input.

By using this to alternately display the blurred selection image Bl and the unblurred selection image Pl, it is possible to produce visual effects in which foreground components of the blurred selection image Bl and foreground components of the unblurred selection image Pl are isolated from background components of the blurred selection image Bl. In the present embodiment, for example, the subject O1 is a foreground subject and the subjects O2 and O3 are background objects. Since the stereoscopic image Pa is displayed in a pseudo-stereoscopic manner, the user can intuitively recognize the atmosphere of the stereoscopic image Pa in a state in which it is displayed stereoscopically.

Particularly in display processing based on the edge component, the parallax d is calculated on the basis of the edge component of the left eye image Pl and the right eye image Pr, and blurring is applied to the blur area pb along the edge component for which the parallax d is less than the predetermined threshold dt. Accordingly, display processing can be performed at high speed without using much computation resource. Therefore, the embodiment of the present disclosure is best suited to the usage for in order to easily represent the atmosphere of the stereoscopic image Pa in a state in which it is displayed stereoscopically.

### [3. Summary]

As described above, the display processing apparatus according to the embodiment of the present disclosure calculates the parallax d of an image element using the left eye image Pl and the right eye image Pr of the stereoscopic image Pa and applies blurring to the area (blur area pb) of the image element for which the parallax d is less than the predetermined threshold dt. Then, the blurred image (for example, the image Bl) and the unblurred image (for example, the image Pl) are alternately displayed. This produces visual effects in which foreground components of the blurred image (for example, the image Bl) and foreground components of the unblurred selection image (for example, the image Pl) are isolated from background components of the blurred image (for example, the image Bl). Since the stereoscopic image Pa is displayed in a pseudo-stereoscopic manner, the user can intuitively recognize the atmosphere of the stereoscopic image Pa in a state in which it is displayed stereoscopically.

A preferred embodiment of the present disclosure has been described above with reference to the drawings, but the present disclosure is not restricted by the above examples. It should be understood by those skilled in the art that various modifications and alterations may occur depending on design requirements and other factors according to an embodiment of the present disclosure.

For example, blurring is performed on the basis of edge components in the above description, but blurring may performed on the basis of other image elements instead of edge components. Blurring is applied only to an area along edge components in the above description, but blurring may be applied to other image elements instead of edge components.

An image element with a smaller parallax d is provided with a wider blur area pb in the above description. However, an image element with a smaller parallax d may be provided with lower brightness or lighter color instead of or in addition to a wider blur area pb. In any of these cases, an image element with a smaller parallax d is provided with larger blurring effects.

The display processing apparatus 10 is integrated with the image display unit 17 in the above description, but the display processing apparatus 10 and the image display unit may be configured independently of each other. In this case, the display processing apparatus 10 may be connected to the image display unit 17, which is configured as a display, monitor, etc., via the input/output interface 35, the communication interface 38, etc. shown in FIG. 2.

The stereoscopic image Pa is displayed in a pseudo-stereoscopic manner in the above description, but a stereoscopic video may be displayed in a pseudo-stereoscopic manner using a similar principle.

The present disclosure contains subject matter related to that disclosed in Japanese Priority Patent Application JP 2010-246737 filed in the Japan Patent Office on Nov. 2, 2010, the entire contents of which are hereby incorporated by reference.

What is claimed is:

1. A display processing apparatus comprising:
an image acquisition unit that acquires a left eye image and a right eye image of a stereoscopic image;
a parallax calculation unit that calculates a parallax for each of image elements contained in the left eye image and the right eye image;
an area setting unit that sets, as a blur area, an area of an image element for which the parallax is less than a predetermined threshold among the image elements contained in a selection image selected as the left eye image or the right eye image;
a blurring unit that applies blurring to the blur area in the selection image; and
a display control unit that alternately displays the selection image to which the burring has been applied and the selection image to which the burring has not been applied yet.

2. The display processing apparatus of claim 1, further comprising an edge detecting unit that detects an edge component forming a boundary of the image element in an image horizontal direction for the left eye image and the right eye image, wherein the parallax calculation unit calculates the parallax based on a difference in the position in the image horizontal direction of the edge component in the left eye image and the right eye image and the area setting unit sets, as the blur area, an area along the edge component for which the parallax is less than a predetermined threshold among the edge components contained in the selection image.

3. The display processing apparatus of claim 2, wherein the edge detecting unit detects, as the edge component, a pixel having a difference in brightness or color that is equal to or more than a predetermined threshold with a left or right adjacent pixel for the left eye image and the right eye image.

4. The display processing apparatus of claim 2, wherein the edge detecting unit detects, as the edge component, a pixel having a difference between a difference in brightness or color with a left adjacent pixel and a difference in brightness or color with a right adjacent pixel that is equal to or more than a predetermined threshold, for the left eye image and the right eye image.

5. The display processing apparatus of claim 1, wherein the blurring unit gives a larger blurring effect to the blur area as the parallax is smaller.

6. The display processing apparatus of claim 2, wherein the blurring unit gives a larger width to the blur area as the parallax is smaller.

7. The display processing apparatus of claim 1, further comprising an image display unit that alternately displays the selection image to which the burring has been applied and the selection image to which the burring has not been applied yet, under control of the display control unit.

8. A display processing method comprising:
acquiring a left eye image and a right eye image of a stereoscopic image;
calculating a parallax for each of image elements contained in the left eye image and the right eye image;
setting, as a blur area, an area of an image element for which the parallax is less than a predetermined threshold among the image elements contained in a selection image selected as the left eye image or the right eye image;
applying blurring to the blur area in the selection image; and
alternately displaying the selection image to which the blurring has been applied and the selection image to which the blurring has not been applied yet.

9. A program that lets a computer execute a display processing method comprising:
acquiring a left eye image and a right eye image of a stereoscopic image;
calculating a parallax for each of image elements contained in the left eye image and the right eye image;
setting, as a blur area, an area of an image element for which the parallax is less than a predetermined threshold among the image elements contained in a selection image selected as the left eye image or the right eye image;
applying blurring to the blur area in the selection image; and
alternately displaying the selection image to which the blurring has been applied and the selection image to which the blurring has not been applied yet.
